(19) United States
(12) Patent Application Publication
(10) Pub. No.: US 2026/0286205 A1
(43) Pub. Date: Sep. 24, 2026

(54) THERMAL INTERFACE MATERIAL

(71) Applicant: COMPAGNIE GENERALE DES ETABLISSEMENTS MICHELIN, Clermont-Ferrand (FR)

(72) Inventors: SALVATORE PAGANO, Clermont-Ferrand (FR); BENOIT CEREDE, Clermont-Ferrand (FR); NINA VERDIER, Clermont-Ferrand (FR)

(21) Appl. No.: 19/471,962

(22) PCT Filed: Apr. 2, 2024
(86) PCT No.: PCT/EP2024/058847

§ 371 Date: Oct. 2, 2025

(30) Foreign Application Priority Data
Apr. 3, 2023 (FR) FR2303292

(51) Int. Cl. C09K 5/14; C08K 3/22; C08L 83/04

(52) U.S. Cl. CPC C09K 5/14; C08K 3/22; C08L 83/04; C08K 2003/2227; C08K 2201/001; C08K 2201/005; C08L 2205/025; C08L 2207/324; C08L 2312/00

(57) ABSTRACT

The invention relates to a thermal interface material, such as thermally conductive pads or thermally conductive sheets, exhibiting good elongation properties, the material being based on an elastomer matrix comprising from 85 to 100 phr of silicone rubber exhibiting a weight-average molar mass, Mw, within a range extending from 150 to 1000 kg/mol; from 250 to 1000 phr of a thermally conductive filler, the thermally conductive filler comprising more than 50% by weight of alumina with respect to the total weight of thermally conductive filler; from 15 to 150 phr of silicone oil exhibiting a viscosity at 25° C. of less than 150 000 mPa·s; and from 0.2 to 5 phr of a crosslinking agent.

The present invention relates to a thermal interface material usable in particular for extracting the heat from an element generating it, for example in the field of storage batteries.

In the field of the propulsion of electric vehicles, it is necessary to have recourse to very high power batteries. The high electric powers deployed during use (battery discharging) or else during recovery (battery charging) cause significant heating actions.

Lithium-ion technology is increasingly used in batteries for motor vehicles. This technology requires an optimum operational temperature range of the battery, on the one hand to fully benefit from the reserve capacity but also and above all to avoid damage during repeated charging/discharging cycles. To prevent this type of damage, systems for regulation/control of the temperature of batteries, referred to as BMSs (Battery Management Systems), are generally used. The thermal part of the BMS generally comprises exchangers with circulating heat-exchange fluids (cooling table) and thermal relays which extract the heat from the battery. These thermal relays (or thermal interfaces) are referred to as TMM or TIM (Thermal Management/Interface Materials). TMMs come in several forms: gap fillers and pads.

Gap fillers are liquid compositions which are crosslinked at ambient temperature to congeal the filling of interstitial volumes between the battery and the cooling table. Pads are, for their part, solid compositions which are shaped into sheets of given thickness. The installing of the pads in the battery packs requires mechanical crushing in order to ensure intimate contact between battery and the cooling table. This installing requires great deformability in order not to result in breakage of the pads.

The thermal conduction property which the pads have to exhibit generally requires a large fraction by volume of thermally conductive fillers in the composition of the TMM. This can weaken these compositions, risking bringing about breakages when fitting the pads to the batteries or when fitting the batteries themselves in the vehicle.

There thus exists a real need to improve the deformability before mechanical breakage of the thermal interface materials usable in pad form which must, by definition, exhibit good thermally conductive properties.

The document CN112831187A describes that compositions based on silicone elastomer comprising spherical alumina, alumina nitride, silicone oil and 2,5-dimethyl-2,5-di(tert-butylperoxy) hexane exhibit good properties of thermal conduction, of sturdiness and of breaking strength.

On continuing its research studies, the Applicant Company has unexpectedly discovered that the combined use of silicone rubber, of thermally conductive filler, of silicone oil and of crosslinking agent, at particular contents, makes it possible to solve the abovementioned technical problem while further improving the deformability before mechanical breakage.

Thus, a subject-matter of the invention is a thermal interface material based on:
an elastomer matrix comprising from 85 to 100 phr of silicone rubber exhibiting a weight-average molar mass, Mw, within a range extending from 150 to 1000 kg/mol,
from 250 to 1000 phr of a thermally conductive filler, the thermally conductive filler comprising more than 50% by weight of alumina with respect to the total weight of thermally conductive filler,
from 15 to 150 phr of silicone oil exhibiting a viscosity at 25° C. of less than 150 000 mPa·s, and
from 0.2 to 5 phr of a crosslinking agent.

### I—DEFINITIONS

The expression “composition based on” should be understood as meaning a composition comprising the mixture and/or the product of the in situ reaction of the various constituents used, some of these constituents being able to react and/or being intended to react with one another, at least partially, during the various phases of manufacture of the composition; it thus being possible for the composition to be in the completely or partially crosslinked state or in the non-crosslinked state. The term “elastomer matrix” is understood to mean the combined elastomers of the composition.

The expression “part by weight per hundred parts by weight of elastomer” (or phr) should be understood as meaning, within the meaning of the present invention, the share by weight per hundred parts of elastomer present in the rubber composition under consideration.

In the present document, unless expressly indicated otherwise, all the percentages (%) indicated are percentages (%) by weight.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b). In the present document, when an interval of values is denoted by the expression “from a to b”, the interval represented by the expression “between a and b” is also and preferentially denoted.

The compounds mentioned in the description can be of fossil origin or can be biobased. In the latter case, they can partially or completely result from biomass or be obtained from renewable starting materials resulting from biomass. In the same way, the compounds mentioned can also originate from the recycling of pre-used materials, that is to say that they can partially or completely result from a recycling process, or also be obtained from starting materials themselves resulting from a recycling process. Polymers, plasticizers, fillers, and the like, are concerned in particular.

Unless otherwise indicated, all the glass transition temperature “Tg” values described in the present document are measured in a known way by DSC (Differential Scanning calorimetry) according to Standard ASTM D3418 (1999).

### II—DESCRIPTION OF THE INVENTION

### II-1 Elastomer Matrix

According to the invention, the elastomer matrix of the thermal interface material is based on from 85 to 100 phr of silicone rubber exhibiting a weight-average molar mass (Mw) within a range extending from 150 to 1000 kg/mol. Below 150 kg/mol, silicone rubber exhibits a consistency and a viscoelastic behaviour of the silicone such that this makes its handling and its processing complex. Moreover, if the Mw of the silicone rubber is too low, the effectiveness of the crosslinking is diminished. Above 1000 kg/mol, silicone rubber exhibits a high consistency and its processing becomes complex and requires high transformation energies. Preferably, the silicone rubber exhibits an Mw within a range extending from 300 to 900 kg/mol, preferably from 500 to 800 kg/mol.

The macrostructure (Mw, Mn and PDI) of the silicone rubber is determined by size exclusion chromatography (SEC); solvent tetrahydrofuran; temperature 35° C.; concentration 1 g/l; flow rate 1 ml/min; solution filtered through a filter with a porosity of 0.45 μm before injection; Moore calibration with polystyrene standards; set of three Waters columns in series (Styragel HR4E, HR1 and HR0.5); detection by differential refractometer (Waters 2410) and its associated operating software (Waters Empower).

The thermal interface material according to the invention can comprise just one silicone rubber or a silicone rubber mixture exhibiting the abovementioned Mw values. In particular, the silicone rubber is selected from the group consisting of polydimethylsiloxanes (PDMSs), polymethylarylsiloxanes (in particular polymethylphenylsiloxanes) and their mixtures. Preferably, the silicone rubber is selected from the group consisting of PDMSs and their mixtures.

The silicone rubber can exhibit vinyl functions. The silicone rubber may, for example, not exhibit a vinyl function or may exhibit it at a molar content which is less than 2%, preferably less than 1%, preferably less than 0.5%. When the silicone rubber exhibits vinyl functions, the molar fraction of vinyl functions within the silicone rubber can be of between 0.01% and 2%, preferably between 0.05% and 1%, preferably between 0.08% and 0.5%.

The molar fraction of vinyl function within the silicone rubber is determined by ¹H and ¹³C NMR spectrometry. The NMR spectra are recorded on a Bruker Avance III 500 MHz spectrometer equipped with a BBI z-grad 5 mm “broad band” cryoprobe. The quantitative ¹H NMR experiment uses a simple 30° pulse sequence and a repetition time of 5 seconds between each acquisition. 64 to 256 accumulations are carried out. The quantitative 13C NMR experiment uses a simple 30° pulse sequence with a proton decoupling and a repetition time of 10 seconds between each acquisition. 1024 to 10 240 accumulations are carried out. ¹H/¹³C two-dimensional experiments are used with the aim of determining the structure of the polymers. The NMR measurements are carried out at 25° C., the copolymers being in solution in a deuterated solvent (approximately 25 mg of elastomer in 1 ml), generally deuterated chloroform (CDCl₃).

The elastomer matrix can comprise elastomers other than silicone rubber but this is neither mandatory nor preferred. Preferably, the elastomeric matrix does not comprise an elastomer other than silicone rubber exhibiting a Mw within a range extending from 150 to 1000 kg/mol or comprises less than 15 phr, preferably less than 10 phr, preferably less than 5 phr, thereof. More preferably, the elastomer matrix comprises only, that is to say 100 phr of, silicone rubber exhibiting a Mw within a range extending from 150 to 1000 kg/mol, preferably from 300 to 900 kg/mol, preferably from 500 to 800 kg/mol.

Mention may be made, as example of silicone rubber of use for the requirement of the invention and commercially available, of Elastosil® R401-10, Elastosil® R401-25, Elastosil® R401-70, Elastosil® R401-90 or Elastosil® R402-75 from Wacker.

### II-2 Thermally Conductive Filler

The thermal interface material according to the invention is based on from 250 to 1000 phr of a thermally conductive filler, the thermally conductive filler comprising more than 50% by weight of alumina with respect to the total weight of thermally conductive filler.

The thermally conductive filler can thus be composed of a mixture of several thermally conductive fillers including more than 50% by weight of alumina but this is neither mandatory nor preferred. Preferably, the thermally conductive filler comprises more than 60% by weight, preferably more than 75% by weight, preferably more than 90% by weight, preferably 100% by weight, of alumina. In other words, the thermally conductive filler preferably does not comprise a filler other than alumina, or comprises less than 40% by weight, preferably less than 25% by weight, preferably less than 10% by weight, thereof.

The alumina can be provided in different forms, in particular in the form of particles. Preferably, the alumina is present in the form of particles, the median diameter D50 of which is within a range extending from 2 to 150 μm, preferably from 10 to 100 μm, preferably from 20 to 70 μm. The D50 represents the diameter of the particles for which 50% of the volume of all of the particles has a smaller diameter and 50% of the volume a greater diameter.

Mention may be made, as example of commercially available alumina, of Silatherm® 1432-006 or 1432-400 or also Silatherm® VST1432-006 or VST1432-400 from Quarzwerke.

Advantageously, the content of the thermally conductive filler in the thermal interface material according to the invention is within a range extending from 370 to 720 phr, preferably from 380 to 600 phr, preferably from 390 to 500 phr, the thermally conductive filler comprising more than 60% by weight, preferably more than 75% by weight, preferably more than 90% by weight, preferably 100% by weight, of alumina.

Whatever the content in phr of thermally conductive filler in the thermal interface material, it is preferable for the content by volume of the thermally conductive filler in the thermal interface material to be within a range extending from 40% to 60%, preferably from 42% to 58%, preferably from 45% to 56%, and for the thermally conductive filler to comprise more than 60% by weight, preferably more than 75% by weight, preferably more than 90% by weight, preferably 100% by weight, of alumina.

### II-3 Silicone Oil

The thermal interface material according to the invention is based on from 15 to 150 phr of silicone oil exhibiting a viscosity at 25° C. of less than 150 000 mPa·s.

The viscosity of the silicone oil is determined at 25° C. and at atmospheric pressure, according to the Brookfield technique. The Brookfield viscosity characterizes, in a known way, liquid substances. The apparent viscosity according to the Brookfield process is measured at a given temperature (for example at 25° C.) according to European and International Standard EN ISO 2555 (1999). Use is made, for example, of a viscometer of the type A (for example the RVT model) or of the type B (for example the HAT model) at a rotational frequency preferentially equal to 10 or 20 min-1, with a number of the spindle (1 to 7) suited to the viscosity range measured (according to Appendix A of Standard EN ISO 2555). The viscosity is expressed in mPa·s or centipoise (cP) (1 cP=1 mPa·s).

Advantageously, the silicone oil exhibits a viscosity at 25° C. within a range extending from 20 to 90 000 mPa·s, preferably from 40 to 50 000 mPa·s, preferably from 50 to 20 000 mPa·s. More preferably, the silicone oil exhibits a viscosity at 25° C. within a range extending from 20 to 20 000 mPa·s, preferably from 40 to 5000 mPa·s, preferably from 50 to 2000 mPa·s.

The silicone oils may or may not be functionalized. Preferably, the silicone oil is a silicone oil not exhibiting a hydroxyl function and/or a vinyl function. More preferably, the silicone oil does not exhibit a polar function and/or a function comprising a double bond.

Mention may be made, as example of silicone oil of use for the requirement of the invention and which is commercially available, of the AK-50, AK-100, AK-1000 or AK-10000 grades or also of the AK-100000 grade from Wacker.

The content of the silicone oil is within a range extending from 15 to 150 phr. Outside this range, it has been found that the mechanical properties (elongation at break, breaking stress) were not satisfactory at contents of thermally conductive filler which are in accordance with the invention. Preferably, the content of the silicone oil in the thermal interface material is within a range extending from 15 to 80 phr, preferably from 20 to 60 phr.

Advantageously, the ratio by weight of the thermally conductive filler to the silicone oil is within a range extending from more than 4.2 to 35, preferably from 5 to 30, preferably from 10 to less than 20, preferably from 10 to less than 18.

In order to further improve the mechanical properties of the thermal interface material, the content of silicone oil which can be used can be adjusted as a function of the viscosity of the silicone oil used. For example, the thermal interface material can comprise from 15 to 35 phr, preferably from 20 to 30 phr, of a silicone oil exhibiting a viscosity at 25° C. of between 50 000 and 150 000 mPa·s.

Preferably, the thermal interface material comprises from 15 to 60 phr, preferably from 15 to 40 phr, preferably from 20 to 35 phr, of a silicone oil exhibiting a viscosity at 25° C. within a range extending from 5000 to 50 000 mPa·s, preferably from 5000 to 20 000 mPa·s.

More preferably, the thermal interface material comprises from 15 to 90 phr, preferably from 15 to 80 phr, preferably from 20 to 75 phr, of a silicone oil exhibiting a viscosity at 25° C. of between 20 and 5000 mPa·s, preferably from 50 to 1500 mPa·s.

### II-4 Crosslinking Agent

The thermal interface material according to the invention is based on from 0.2 to 5 phr of a crosslinking agent.

The crosslinking agent can be any crosslinking agent making it possible to crosslink a silicone rubber. Advantageously, the crosslinking agent is a peroxide or a mixture of several peroxides. It can be any peroxide known to a person skilled in the art. Among the peroxides, which are well known to a person skilled in the art, it is preferable to use, in the context of the present invention, an organic peroxide.

“Organic peroxide” is understood to mean an organic compound, that is to say a compound containing carbon, comprising an —O—O— group (two oxygen atoms bonded by a single covalent bond). During the crosslinking process, the organic peroxide decomposes at its unstable O—O bond to give free radicals. These free radicals make possible the creation of the crosslinking bonds.

The organic peroxide is preferably selected from the group comprising or consisting of dialkyl peroxides, monoperoxycarbonates, diacyl peroxides, peroxyketals and peroxyesters.

Preferably, the dialkyl peroxides are selected from the group comprising or consisting of dicumyl peroxide, di(t-butyl) peroxide, t-butyl cumyl peroxide, 2,5-dimethyl-2,5-di(t-butylperoxy) hexane, 2,5-dimethyl-2,5-di(t-amylperoxy)hexane, 2,5-dimethyl-2,5-di(t-butylperoxy) hex-3-yne, 2,5-dimethyl-2,5-di(t-amylperoxy)hex-3-yne, bis[α-(t-butylperoxy) isopropyl]benzene, bis[α-(t-amylperoxy)isopropyl]benzene, di(t-amyl) peroxide, 1,3,5-tri[(t-butylperoxy) isopropyl]benzene, 1,3-dimethyl-3-(t-butylperoxy) butanol and 1,3-dimethyl-3-(t-amylperoxy)butanol.

Certain monoperoxycarbonates, such as OO-tert-butyl O-(2-ethylhexyl) monoperoxycarbonate, OO-tert-butyl O-isopropyl monoperoxycarbonate and OO-tert-amyl O-(2-ethylhexyl) monoperoxycarbonate, can also be used.

Among the diacyl peroxides, the preferred peroxide is benzoyl peroxide.

Among the peroxyketals, the preferred peroxides are selected from the group comprising or consisting of 1,1-di(t-butylperoxy)-3,3,5-trimethylcyclohexane, n-butyl 4,4-bis(t-butylperoxy) valerate, ethyl 3,3-di(t-butylperoxy) butyrate, 2,2-di(t-amylperoxy) propane, 3,6,9-triethyl-3,6,9-trimethyl-1,4,7-triperoxynonane (or methyl ethyl ketone peroxide cyclic trimer), 3,3,5,7,7-pentamethyl-1,2,4-trioxepane, n-butyl 4,4-bis(t-amylperoxy) valerate, ethyl 3,3-di(t-amylperoxy) butyrate, 1,1-di(t-butylperoxy)cyclohexane, 1,1-di(t-amylperoxy)cyclohexane and their mixtures. Preferably, the peroxyesters are selected from the group consisting of tert-butyl peroxybenzoate, tert-butyl peroxy-2-ethylhexanoate and tert-butyl peroxy-3,5,5-trimethylhexanoate.

To sum up, the organic peroxide is particularly preferably selected from the group consisting of dicumyl peroxide, aryl peroxides, diaryl peroxides, diacetyl peroxide, benzoyl peroxide, dibenzoyl peroxide, di(tert-butyl) peroxide, tert-butyl cumyl peroxide, 2,5-bis(tert-butylperoxy)-2,5-dimethylhexane, n-butyl 4,4-bis(tert-butylperoxy) valerate, OO-(t-butyl)O-(2-ethylhexyl) monoperoxycarbonate, tert-butylperoxy isopropyl carbonate, tert-butyl peroxybenzoate, tert-butyl peroxy-3,5,5-trimethylhexanoate, 1,3(4)-bis(tert-butylperoxyisopropyl)benzene and their mixtures. More preferably, the organic peroxide is selected from the group consisting of dicumyl peroxide, n-butyl 4,4-bis(tert-butylperoxy) valerate, OO-(t-butyl)O-(2-ethylhexyl) monoperoxycarbonate, tert-butylperoxy isopropyl carbonate, tert-butyl peroxybenzoate, tert-butyl peroxy-3,5,5-trimethylhexanoate, 1,3(4)-bis(tert-butylperoxyisopropyl)benzene and their mixtures.

Mention may be made, by way of example of peroxide which can be used in the context of the present invention and which is commercially available, of Dicup from Hercules Powder Co., Perkadox Y12 from Noury van der Lande, Peroximon F40 from Montecatini Edison S.p.A., Trigonox from Noury van der Lande, Varox from R.T. Vanderbilt Co. or also Luperko from Wallace & Tiernan Inc.

### II-5 Possible Additives

The thermal interface material can optionally also comprise all or part of the usual additives generally used in TMMs, such as, for example, pigments, protective agents, antioxidants or flame retardants.

### II-6 Preparation of the Compositions

The materials in accordance with the invention can be manufactured in appropriate mixers, using two successive preparation phases well known to a person skilled in the art:
a first phase of thermomechanical working or kneading (“non-productive” phase), which can be carried out in a single thermomechanical stage during which all the necessary constituents, in particular the elastomer matrix, the thermally conductive filler and the various other optional additives, with the exception of the crosslinking system, are introduced into an appropriate mixer, such as a standard internal mixer (for example of Banbury type). The incorporation of the filler in the elastomer can be carried out in one or more goes while thermomechanically kneading. In the case where the filler is already incorporated, completely or partly, in the elastomer in the form of a masterbatch, as is described, for example, in Applications WO 97/36724 and WO 99/16600, it is the masterbatch which is directly kneaded and, if appropriate, the other elastomers or fillers present in the composition which are not in the masterbatch form, and also the various other optional additives, other than the crosslinking system, are incorporated. The non-productive phase can be carried out at high temperature, up to a maximum temperature of between 80° C. and 150° C., preferably between 100° C. and 120° C., for a period of time generally of between 2 and 10 minutes.
a second phase of mechanical working (“productive” phase), which can be carried out in an external mixer, such as an open mill, after cooling the mixture obtained during the first non-productive phase down to a lower temperature, typically of less than 120° C., for example between 40° C. and 100° C. The crosslinking system is then incorporated and the combined mixture is then mixed for a few minutes, for example between 5 and 15 min.

Such phases have been described, for example, in Applications EP-A-0 501 227, EP-A-0 735 088, EP-A-0 810 258, WO 00/05300 and WO 00/05301.

The final composition thus obtained is subsequently calendered, for example in the form of a sheet or of a plaque.

These products can subsequently be used in the manufacture of thermal interface materials, such as thermally conductive pads (or cushions) or thermally conductive sheets, according to techniques known to a person skilled in the art. The composition can in particular be moulded and crosslinked, for example at a temperature of between 130° C. and 200° C., under pressure, to form a thermal interface pad.

### II-7 Thermal Interface Material

The thermal interface material in accordance with the invention can be used for any application making it possible to extract the heat emitted by an object. For example, it is particularly well suited to transferring the heat emitted by an electric car battery during use or during its recharging.

The thermal interface material in accordance with the invention can be provided in any shape and according to any thickness making it possible for it to fulfil its function. Preferably, the thermal interface material is selected from the group consisting of thermally conductive pads (or cushions) and thermally conductive sheets. In addition, the thermal interface material preferably exhibits a thickness within a range extending from 0.2 to 10 mm, preferably from 0.5 to 8 mm, preferably from 1 to 6 mm, preferably from more than 1 to 6 mm, preferably from 1.1 to 6 mm.

### III—EXAMPLES

### III-1 Preparation of the Compositions

In the examples which follow, the rubber compositions were produced as described in point II-6 above. In particular, the “non-productive” phase was carried out in a 0.4 litre mixer for 3.5 minutes, for a mean blade speed of 50 revolutions per minute, until a maximum dropping temperature of 90° C. was reached. The “productive” phase was carried out in an open mill at 40° C. for 5 to 10 minutes. The crosslinking of the composition was carried out at a temperature of 150° C. for 30 minutes, under pressure. Test specimens targeted at measuring the tensile mechanical properties (modulus and elongation) were cut out from the crosslinked plaques obtained.

### III-2 Measurements and Tests Used

### Mechanical Properties

These tensile tests make it possible to determine the elasticity stresses and the properties at break. Processing of the tensile recordings also makes it possible to plot the curve of modulus as a function of the elongation, the modulus used here being the nominal (or apparent) secant modulus measured in first elongation, calculated by reducing to the initial cross section of the test specimen. The breaking stresses (BS in MPa) and the elongations at break (EB in %) are measured, at 23° C.±2° C., according to Standard NF T 46-002 of September 1988. The breaking energy is equal to the product of the elongation at break and the breaking stress.

### Thermal Conductivity

Cylindrical samples with dimension of 40 mm×8 mm were prepared by moulding. A TPS 1000 device of the Hot Disk trade mark is used to determine the thermal conductivity by the Transient Plane Source (TPS) method. A heat flux with a power of 80 mW is applied to the sample for 10 seconds. The thermal conductivity of the sample is thus determined by the variation in temperature observed, which is itself determined by a measurement of the variation in electrical resistance of the material via a Wheatstone bridge in the sample.

### III-3 Tests on Rubber Compositions

The object of the examples presented below is to compare the properties of elongation at break of compositions in accordance with the present invention (I1 to I10) with two control compositions (C1 and C2).

The compositions tested (in phr), and also the results obtained, are presented in Table 1.

The compositions in accordance with the invention differ from the control compositions in the contents of thermally conductive filler and of silicone oil, the fraction by volume of thermally conductive filler being constant.

TABLE 1

| | C1 | C2 | I1 | I2 | I3 | I4 |
|---|---|---|---|---|---|---|
| Ingredients | | | | | | |
| Silicone elastomer (a) | 100 | 100 | 100 | 100 | 100 | 100 |
| Thermally conductive filler (b) | 318 | 361 | 416 | 487 | 581 | 712 |
| Fraction by volume of (b) | 50% | 50% | 50% | 50% | 50% | 50% |
| Silicone oil (c1) 10.000 | | 11 | 25 | 43 | 67 | 100 |
| Peroxide (d) | 1 | 1 | 1 | 1 | 1 | 1 |
| Ratio (b)/(c1) | / | 32.82 | 16.64 | 11.33 | 8.67 | 7.12 |
| Mechanical properties | | | | | | |
| EB (%) | 25 | 34 | 200 | 214 | 97 | 108 |
| BS (MPa) | 3.0 | 2.7 | 5.3 | 4.2 | 1.9 | 1.4 |
| Breaking energy (EB*BS) | 75 | 91.8 | 1060 | 898.8 | 184.3 | 151.2 |
| Thermal properties | | | | | | |
| Thermal conductivity (W/K · m) | 1.4 | 1.4 | 1.3 | 1.3 | 1.2 | 1.2 |

(a) Silicone elastomer R401/70 from Wacker and weight Mn = 350 kg/mol, weight Mw = 620 kg/mol (SEC RI PS)
(b) Silatherm 1432-006 alumina from Quarzwerke, the D50 size of which is 46 μm
(c1) Silicone oil AK10000 from Wacker with a viscosity of 10 000 mPa · s.
(d) Dicumyl peroxide from Sigma-Aldrich

TABLE 2

| | I5 | I6 | I7 | I8 | I9 | I10 |
|---|---|---|---|---|---|---|
| Ingredients | | | | | | |
| Silicone elastomer a) | 100 | 100 | 100 | 100 | 100 | 100 |
| Thermally conductive filler (b) | 416 | 581 | 712 | 416 | 712 | 416 |
| Fraction by volume of (b) | 50% | 50% | 50% | 50% | 50% | 50% |
| Silicone oil (c2) 100 | | | | 25 | 100 | |
| Silicone oil (c3) 1.000 | 25 | 67 | 100 | | | |
| Silicone oil (c4) 100.000 | | | | | | 25 |
| Peroxide (d) | 1 | 1 | 1 | 1 | 1 | 1 |
| Ratio (b)/(c2 or c3 or c4) | 16.64 | 8.67 | 7.12 | 16.64 | 7.12 | 16.64 |
| Mechanical properties | | | | | | |
| EB (%) | 222 | 322 | 320 | 265 | 393 | 174 |
| BS (MPa) | 5.5 | 3.6 | 2.1 | 5.6 | 2.2 | 4.8 |
| Breaking energy (EB*BS) | 1221 | 1159.2 | 672 | 1484 | 864.6 | 835.2 |
| Thermal properties | | | | | | |
| Thermal conductivity (W/K · m) | 1.3 | 1.2 | 1.2 | 1.2 | 1.2 | 1.4 |

(a), (b), (d): See Table 1
(c2) Silicone oil AK100 from Wacker with a viscosity of 100 mPa · s
(c3) Silicone oil AK1000 from Wacker with a viscosity of 1000 mPa · s
(c4) Silicone oil AK100000 from Wacker with a viscosity of 100 000 mPa · s

The results presented in Table 1 above show that the compositions in accordance with the invention all exhibit much greater elongations at break than the control compositions, this being the case without excessively impacting the thermal conductivity of the composition, indeed even without impacting it at all. In particular, the increase in the content of silicone oil at a constant fraction by volume of thermally conductive filler makes it possible to improve the elongation at break and the breaking energy. Comparison of the compositions I1, I5, I8 and I10 or of the compositions I4 and I7 shows that, the lower the viscosity of the oil, the better the elongation at break and the breaking stress at a given content. The greatest elongations at break are achieved when the viscosity of the silicone oil is lowest and when the contents of these silicone oils are highest.

Thus, the compositions in accordance with the invention make it possible to obtain thermal interface materials which are highly deformable, which makes them particularly advantageous to be used in particular as thermally conductive pads or sheets.

1.-15. (canceled)

16. A thermal interface material based on:
an elastomer matrix comprising from 85 to 100 phr of silicone rubber exhibiting a weight-average molar mass, Mw, within a range extending from 150 to 1000 kg/mol;
from 250 to 1000 phr of a thermally conductive filler, the thermally conductive filler comprising more than 50% by weight of alumina with respect to a total weight of thermally conductive filler;
from 15 to 150 phr of silicone oil exhibiting a viscosity at 25° C. of less than 150,000 mPa·s; and
from 0.2 to 5 phr of a crosslinking agent.

17. The thermal interface material according to claim 16, wherein the silicone rubber is selected from the group consisting of polydimethylsiloxanes, polymethylarylsiloxanes and mixtures thereof.

18. The thermal interface material according to claim 16, wherein the silicone rubber does not exhibit a vinyl function or exhibits a vinyl function at a molar content which is less than 2%.

19. The thermal interface material according to claim 16, wherein the silicone rubber exhibits a Mw within a range extending from 300 to 900 kg/mol.

20. The thermal interface material according to claim 16, wherein a content of the thermally conductive filler is within a range extending from 370 to 720 phr.

21. The thermal interface material according to claim 16, wherein a content by volume of the thermally conductive filler in the thermal interface material is within a range extending from 40% to 60%.

22. The thermal interface material according to claim 16, wherein the thermally conductive filler comprises more than 60% by weight of alumina.

23. The thermal interface material according to claim 22, wherein the alumina is present in a form of particles, a median diameter D50 of which is within a range extending from 2 to 150 μm.

24. The thermal interface material according to claim 16, wherein the silicone oil is a silicone oil not exhibiting a hydroxyl function and/or a vinyl function.

25. The thermal interface material according to claim 16, wherein the silicone oil exhibits a viscosity within a range extending from 20 to 20,000 mPa·s.

26. The thermal interface material according to claim 16, wherein a content of the silicone oil is within a range extending from 15 to 80 phr.

27. The thermal interface material according to claim 16, wherein a ratio by weight of the thermally conductive filler to the silicone oil is within a range extending from more than 4.2 to 35.

28. The thermal interface material according to claim 16, wherein the crosslinking agent is an organic peroxide.

29. The thermal interface material according to claim 16, wherein the thermal interface material is selected from the group consisting of thermally conductive pads and thermally conductive sheets.

30. The thermal interface material according to claim 16, wherein the thermal interface material exhibits a thickness within a range extending from 0.2 to 10 mm.
